(19) United States
(12) Patent Application Publication
(10) Pub. No.: US 2024/0191494 A1
(43) Pub. Date: Jun. 13, 2024

(54) BRACING ARRANGEMENT

(71) Applicant: Autostore Technology AS, Nedre Vats (NO)

(72) Inventors: Trond Austrheim, Etne (NO); Børge Bekken, Haugesund (NO); Martin Fitje, Etne (NO)

(73) Assignee: Autostore Technology AS, Nedre Vats (NO)

(21) Appl. No.: 18/551,345

(22) PCT Filed: Mar. 24, 2022
(86) PCT No.: PCT/EP2022/057805

§ 371 Date: Sep. 19, 2023

(30) Foreign Application Priority Data
Mar. 25, 2021 (NO) 20210390

(51) Int. Cl. E04B 1/19; B65G 1/04

(52) U.S. Cl. CPC E04B 1/19; B65G 1/0464; E04B 2001/1924

(57) ABSTRACT

A bracing arrangement for a framework structure of an automated storage and retrieval system includes a plurality of upright members arranged in rows defining storage columns. The upright members support a rail system comprising first and second sets of parallel rails upon which travel container handling vehicles for retrieving containers or other items stored in the storage columns. A plurality of twin-post upright members are arranged in at least one row of the framework structure. The twin-post upright members include a pair of upright member sections arranged with a space therebetween. At least one elongated bracing member is connected at a first end to a first upper connection point and at a second end to a second lower connection point in order to brace the framework structure. Each elongated bracing member is arranged to pass diagonally through the spaces between the vertical sections of the pairs of upright member sections of the plurality of twin-post upright members arranged in the at least one row.

### FIELD OF THE INVENTION

The present invention relates to structural bracing, in particular to bracing a framework structure of an automated storage and retrieval system for storage and retrieval of containers.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,301b,201c,301c,401b,401c which enable the lateral movement of the container handling vehicles 201,301,401 in the X direction and in the Y direction, respectively. In FIGS. 2, 3 and 3B two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 301b, 201c, 301c, 401b,401c can be lifted and lowered, so that the first set of wheels 201b, 301b,401b and/or the second set of wheels 201c, 301c, 401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 3B and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 3B, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

### Bracing of the Framework Structure

The framework structure 100 may be subjected to significant lateral forces, such as by the motion of the vehicles operating on the rail system 108. The framework structure 100 may also be subjected to tremors or other destabilizing forces. The framework structure therefore generally requires bracing. The framework structure 100 is typically braced by beams 501 connecting the uppers rails of the track system to the walls of the building in which the framework structure is erected, as shown in prior art FIG. 4. Typically beams 501 are arranged on at least two sides of the framework structure, spaced approximately every 10 meters. In this instance, the normal, prior art upright members 102 are also arranged along the periphery of the framework structure, as illustrated in prior art FIG. 5.

It is not always possible or desirable to brace the framework structure 100 as described above, however. Furthermore, the above described bracing arrangement does not provide a grid that is self-standing, i.e. one that does not require bracing against an external structure.

In another example from the prior art, the present applicant has previously described in WO 2019101367 a system whereby a plurality of inclined supporting struts is connected between adjacent pairs of upright members 102 along the periphery of the framework structure. While the struts from WO 2019101367 provide stability and allow the framework structure to be self-supporting, the connection of multiple bracing struts (one between every pair of adjacent upright members) is time consuming and difficult. There is therefore room for improvement in providing a simpler and more flexible arrangement for stabilizing the framework structure 100. Furthermore the arrangement in WO 2019101367 does not provide a means of tensioning the supporting struts.

There is a therefore a need for an improved or supplemental or alternative arrangement and method for bracing the framework structure.

### SUMMARY OF THE INVENTION

The present invention is set forth and characterized in the independent claims, while the dependent claims describe other characteristics of the invention.

In one aspect, the invention is related an arrangement and method for bracing the framework structure of an automated storage and retrieval system. In another aspect, the invention relates to a twin-post upright member useful in the arrangement and method.

According to one aspect, the invention provides a bracing arrangement for a framework structure of an automated storage and retrieval system, comprising:
a. a plurality of twin-post upright members arranged in at least one row of the framework structure, the twin-post upright members comprising a pair of upright member sections arranged with a space therebetween,
b. at least one elongated bracing member connected at a first end to a first connection point and at a second end to a second connection point in order to brace the framework structure, and
c. each elongated bracing member arranged to pass through the spaces between the vertical sections of the pairs of upright member sections arranged in the at least one row.

The arrangement according to one aspect comprises a plurality of twin-post upright members arranged as the upright members of the outer periphery of the framework structure. The twin-post upright members comprise two vertical upright member sections separated by spacers, thereby creating a space between the vertical upright member sections. An elongated bracing member is connected at one end to a first connection point, passes through the space between the sections of a plurality of twin-post upright members, and is attached at a second connection point. In one embodiment, the bracing member is arranged diagonally. For example, it may be attached at its lower end to the floor of the facility and/or at its upper end to the outer rails of rail system, with the bracing member passing through the space between the vertical sections of the twin-post upright members therebetween. In another embodiment the bracing member is arranged horizontally and the first and second connection points may be upright members or other structure of the storage and retrieval system. The bracing member may comprise a turnbuckle or other tensioning means for tightening and stiffening the bracing member in order to brace the framework structure. When so braced, the framework structure will be self-supporting, i.e. not requiring any bracing connections to surrounding structures such as the internal walls of a building.

In one aspect, the upper end of the bracing member is connected to an upper part of the framework structure, for example to the rails upon which vehicles of the system travel, by a fixture, such as a connection plate, that is no wider than the width of the rails. In this way, neither the bracing member nor the connection plate interfere with the vertical movement of containers within the columns adjacent to the bracing member.

In another aspect, where possible interference with adjacent columns is not an issue, the bracing member may be connected to rails by a bracket or clamp rigidly connected to the side surfaces of the rails.

In one aspect, a lowermost spacer between the vertical sections comprises a hole or recess for accepting the guide pin of a leveling foot device arranged between the upright member and the floor.

The twin-post upright members according to one aspect also comprise one or more longitudinal corner guide profiles that vertically guide a storage container in a storage column when such storage column is defined by one or more such twin-post upright member.

According to one aspect, the invention provides a method for bracing a framework structure comprising the steps of:
arranging a plurality of twin-post upright members as at least one row of upright members of the framework structure,
connecting a first end of an elongated bracing member to a floor of the facility in which the framework structure is erected or to a rail of a rail system upon which vehicles of the automated storage and retrieval system operate,
passing the elongated bracing member diagonally through the space between upright member sections of multiple adjacent upright members of the row,
connecting a second end of the elongated bracing member to the floor or rail.

While the invention will be described in connection with an embodiment where the twin-post upright members and the bracing members are arranged about the periphery of the framework structure it should be understood that twin-post upright members and the bracing members can be arranged at a location to the interior of the framework structure if desirable. This would provide the advantage of allowing internal structural bracing that does not interfere with the operation of storage columns, while also allowing the periphery of the framework structure to be protected by covers etc. The arrangement of internal bracing also allows a central region of the framework structure to be braced and for that central region to then support outer regions of the framework structure. According to one aspect, bracing arrangements according to the invention can be arranged at regular intervals, for example every 10 meters.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of an automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilever for carrying storage containers underneath.

FIG. 4. Illustrates a prior art bracing arrangement where the framework structure is connected to an external structure such as a wall.

FIG. 5 is a view of a prior art upright members arranged at the periphery of a framework structure.

FIG. 6 is an illustration of an exemplary embodiment of the bracing arrangement of the invention, showing only the pairs of upright member sections at the outer periphery of a framework structure, with bracing members extending between the upright member sections.

FIG. 7 is an exploded view of a pair of upright member sections either side of a grid foot leveling device.

FIG. 8 is a detailed perspective view showing one embodiment of the connection of a lower end of a bracing member to the floor of the facility in which the framework structure is erected

FIG. 9 is a detailed perspective view showing one embodiment of the connection of an upper end of a bracing member to the rail system of the framework structure.

FIG. 10 illustrates that in one aspect, the same connection plate may be used at both the upper and lower ends of the bracing member.

FIG. 11 is a detailed perspective view showing another embodiment of the connection plate used with a bracing member to the rail system of the framework structure.

FIG. 12 is a detailed perspective view of a row of twin-post upright members, either arranged along the periphery of the framework structure or at the interior of the framework structure, and showing yet another embodiment of a connection of a bracing member to the rail system of the framework structure.

FIG. 13 is a detailed perspective view of a row of twin-post upright members, either arranged along the periphery of the framework structure or at the interior of the framework structure, and showing yet another embodiment of a connection of a bracing member to the rail system of the framework structure.

FIG. 14 is a detailed perspective view showing three embodiments of a connection of a bracing member to the rail system of the framework structure for comparison purposes.

FIG. 15 is a detailed perspective view showing the bracing member passing through the space between vertical sections of a pair of upright member sections, with the upright member sections resting on a grid foot leveling device.

FIG. 16 is an overhead view of FIG. 15.

FIGS. 17-20 show a container arranged in a column adjacent to the pairs of upright member sections and bracing members, illustrating that the bracing member and connections do not interfere with the movement of the container in the column.

FIGS. 21-24 show an alternate arrangement of the bracing members, where the bracing members are arranged as segments or spokes connected to a center ring or hub.

FIG. 25 shows a bracing arrangement placed in the interior of a framework structure.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

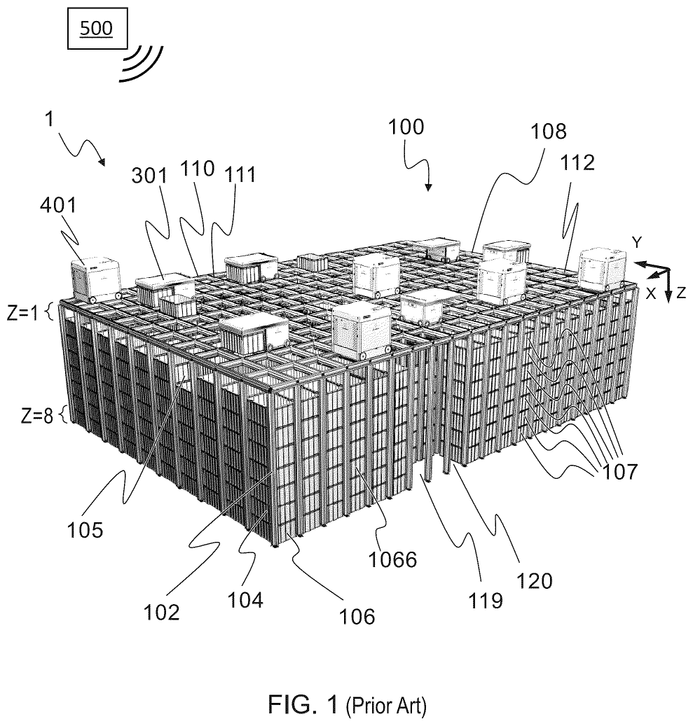

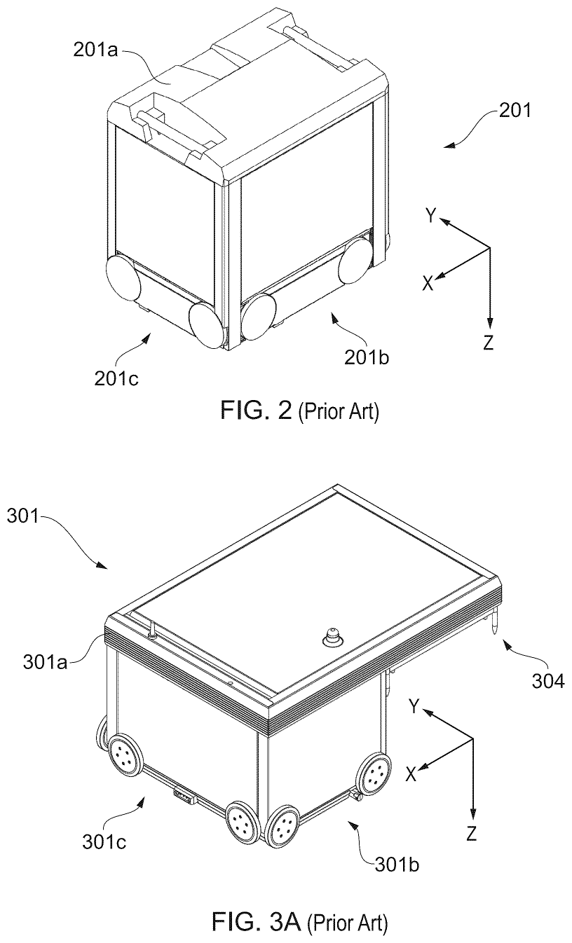

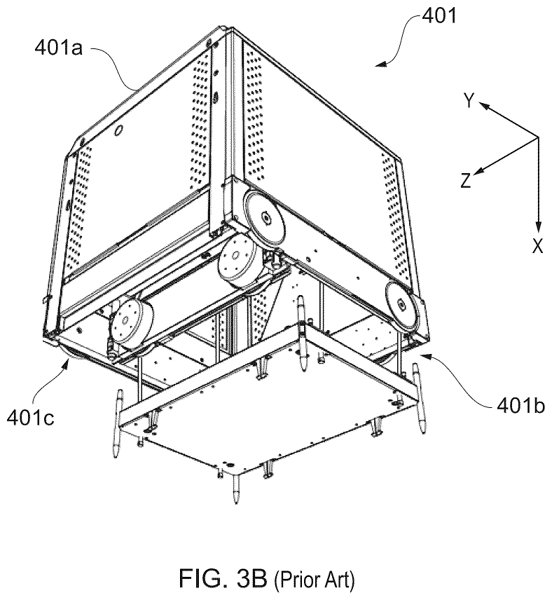

The present invention relates to a bracing arrangement for an automated storage and retrieval system 1 as described in the background section of this application. The framework structure 100 of the automated storage and retrieval system 1, except as otherwise explained below, is constructed in accordance with the prior art framework structure 100 described above and as illustrated in FIGS. 1-3, i.e. a number of upright members 102, which are supported by the upright members 102, and further that the framework structure 100 comprises a first, upper rail system 108 in the X direction and Y direction.

The framework structure 100 further comprises storage compartments in the form of storage columns 105 provided between the members 102, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

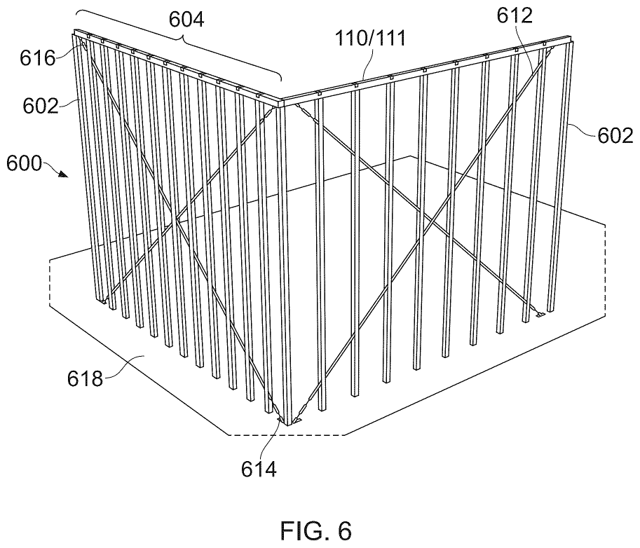

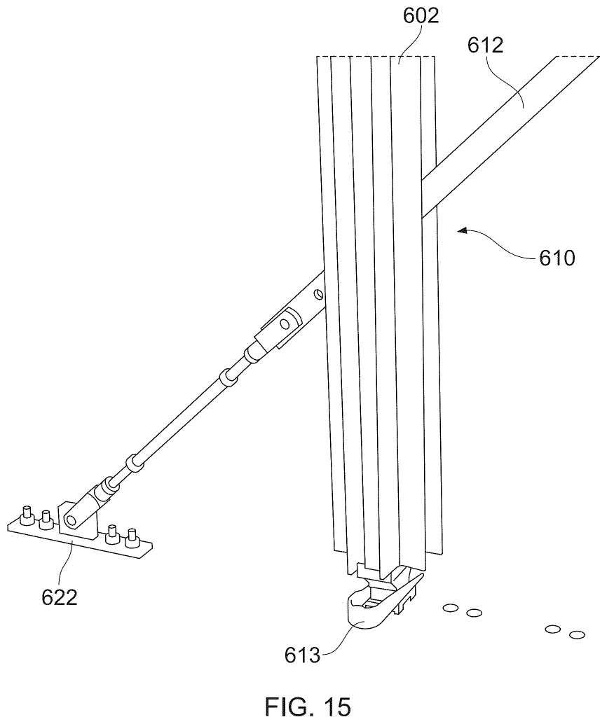

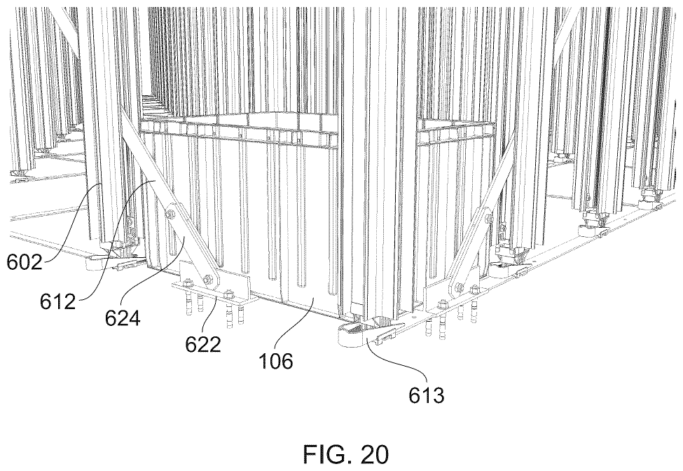

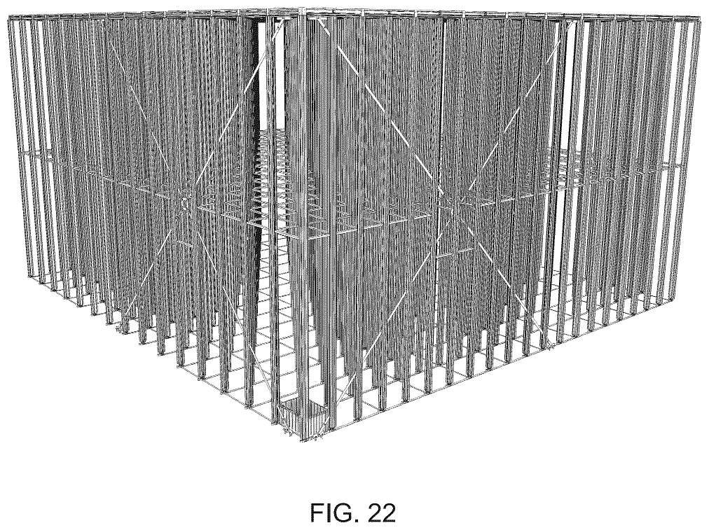

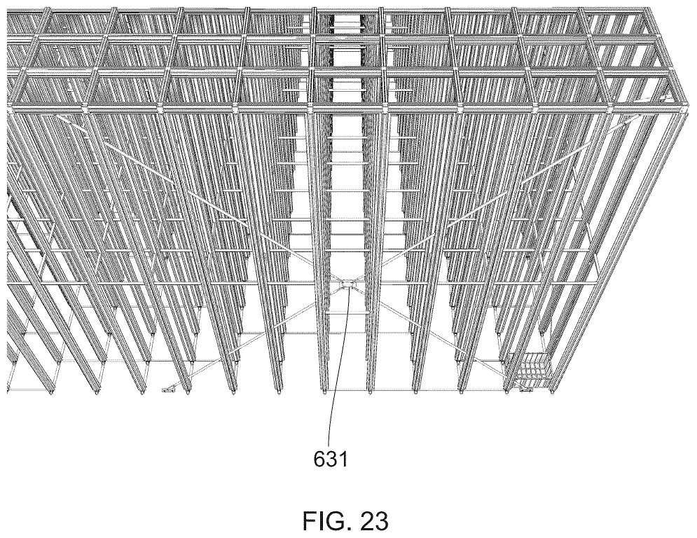

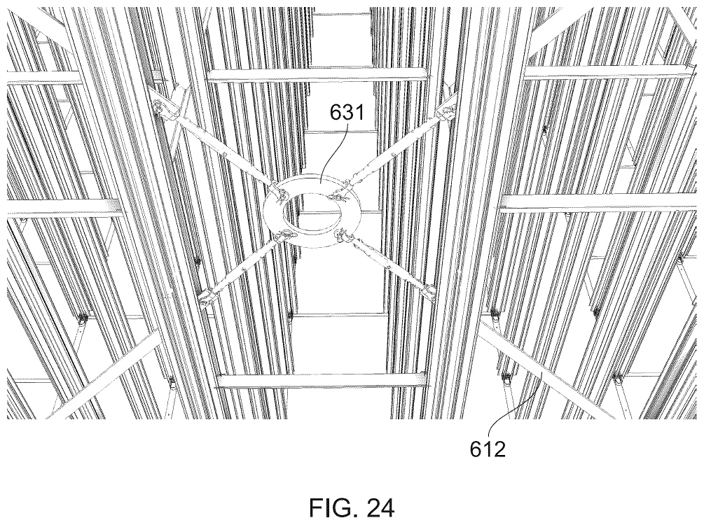

One embodiment of the automated storage and retrieval system according to the invention will now be discussed in more detail with reference to FIGS. 6-24.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

FIG. 6 illustrates two sides of a periphery 600 of a framework structure 100 of an automated storage and retrieval system 1. Interior upright members 102 and rail system 108 of the framework structure 100, such as illustrated in FIG. 1, are not shown in FIG. 6 for ease of illustration. According to one aspect, the invention comprises a plurality of twin-post upright members 602 arranged in a row 604. In one aspect, row or rows 604 are arranged along at least one side, preferably along at least two sides, of periphery 600. According to another aspect, row or rows 604 may be arranged in the interior of framework structure 100.

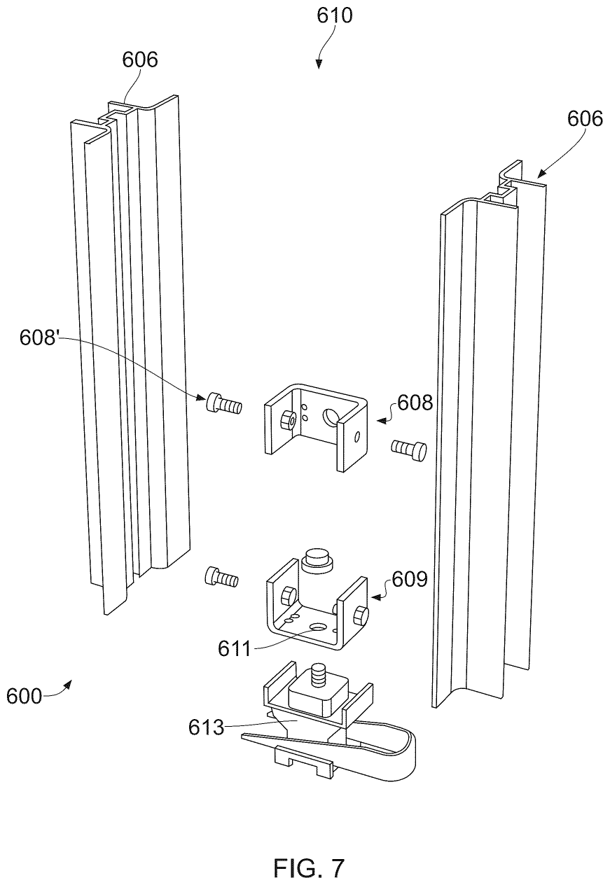

FIG. 7 is an exploded view of a twin-post upright member 602. As shown, the twin-post upright member 602 comprises two upright member sections 606 joined together by one or more spacers 608. When so joined, a space 610 is created between upright member sections 606. In one aspect, a lowermost spacer 609 comprises a hole or slot 611 arranged to engage a leveling foot device 613.

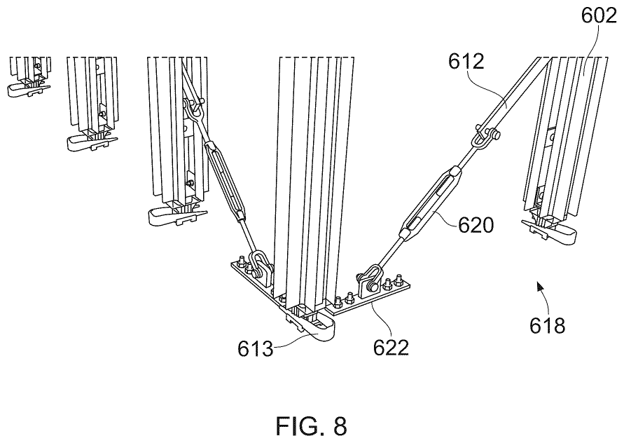

As further shown in FIG. 6, a plurality of elongated bracing members 612 are arranged to pass through spaces 610 of the twin-post upright member 602 of row 604. In one embodiment the bracing member may be a rigid member such as a brace bar or strut. In another embodiment the bracing member may be a flexible structure such as a cable or wire. In one embodiment, the bracing member passes diagonally through a plurality of twin-post upright members. In another embodiment, the bracing member passes horizontally through a plurality of twin-post upright members. The bracing members are attached at one end to a first connection point 614 and at another end to a second connection point 616. In one aspect, first connection point 614 is a floor 618 of the facility in which framework structure 100 is erected and the second attachment point is a rail 110/110 of rail system 108. According to this aspect the bracing members are arranged diagonally as shown in FIG. 6. Bracing members 612 preferably comprise tensioning means, for example a turnbuckle 620 as shown in FIG. 8. Turnbuckle 620 is rotated to apply tension to bracing member 612. Other forms of tensioner can be used too.

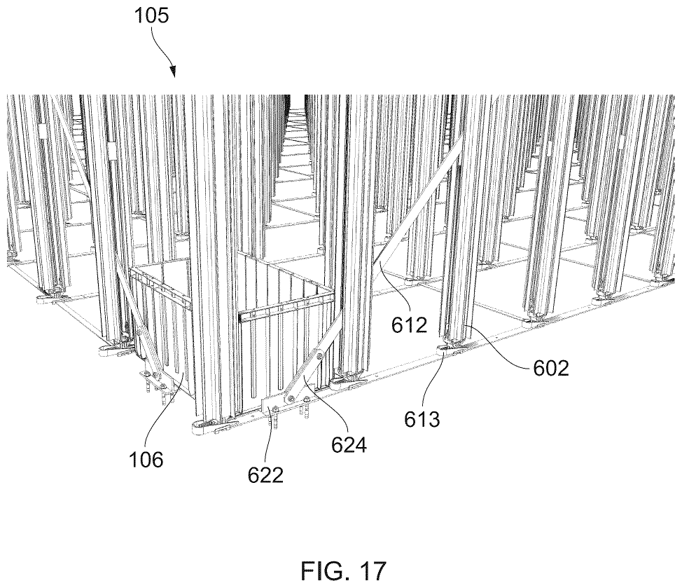

FIG. 8 is a detailed view of a connection plate 622 bolted to floor 618. Turnbuckle 620 connects bracing member 612 to connection plate 622. It should be understood however, that bracing member 612 could be connected directly to connection plate 622, or connected via an articulated connection piece 624 as shown in FIG. 17, with turnbuckle (or other tensioning means) arranged at the opposite end of the bracing member, or intermediate the ends of the bracing member.

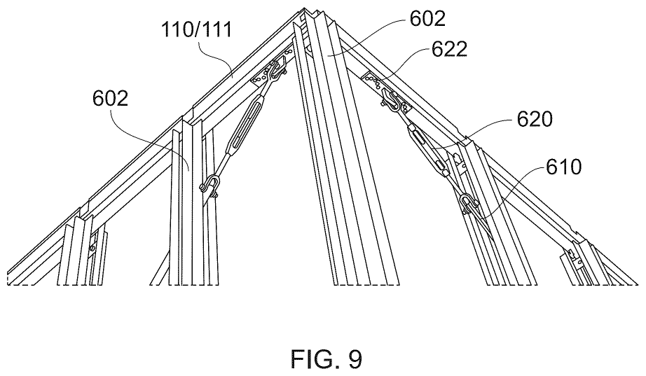

FIG. 9 is a detailed view showing bracing member 612 connected to the underside of rail 110/111 by connection plate 622 and shows bracing member 612 passing through space 610. FIG. 9 shows a preferable arrangement where connection plate 622 has a width that does not exceed the width of rail 110/111. As will be described below, this is an advantageous arrangement that avoids connection plate 622 interfering with the vertical movement of storage containers in storage columns adjacent to the connection point.

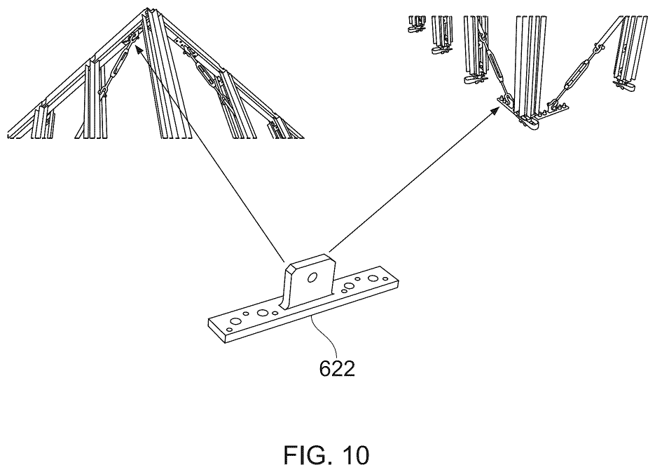

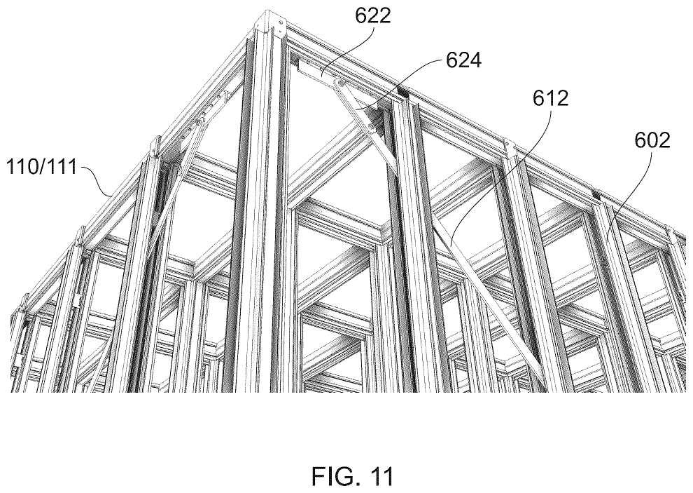

In a preferable arrangement as illustrated in FIG. 10, identical connection plates 622 are used to connect both ends of bracing member 612, as this creates an efficiency of manufacture and installation. FIG. 11 shows an alternate arrangement of a connection plate 622, with bracing member 612 connected to the upper connection plate by an articulated connection piece 624.

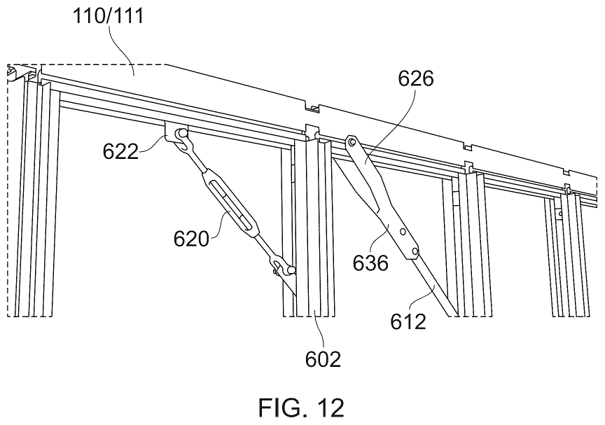

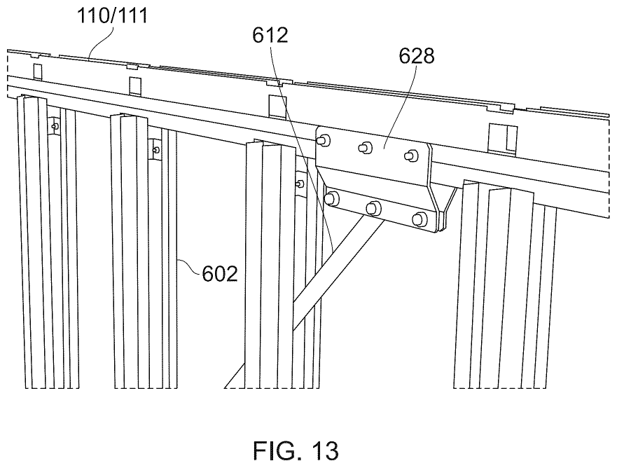

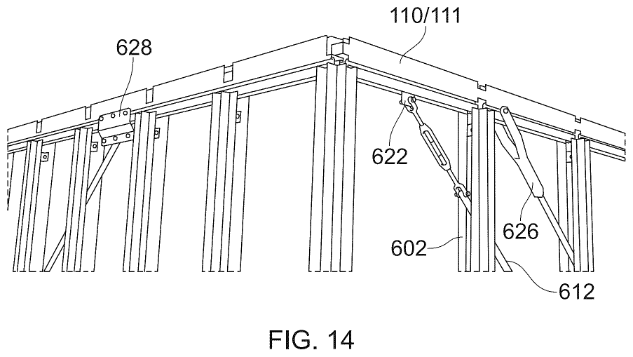

FIG. 12 shows an alternative arrangement for connecting bracing member 612 to rail 110/111, shown beside the embodiment described above for the sake of comparison. This alternative arrangement comprises a forked connector 626 arranged about the outside of rail 110/111 with a bolt passing therethrough. This arrangement may be useful where the risk of interference of the vertical movement of containers in an adjacent storage column is not an issue. FIG. 13 illustrates yet another alternative means of connecting the bracing member 612 to rail 110/111, with a two-sided connection bracket 628 bolted to the sides of rail 110/111 at multiple points. FIG. 14 illustrates the three alternatives described above in the same figure for the sake of comparison.

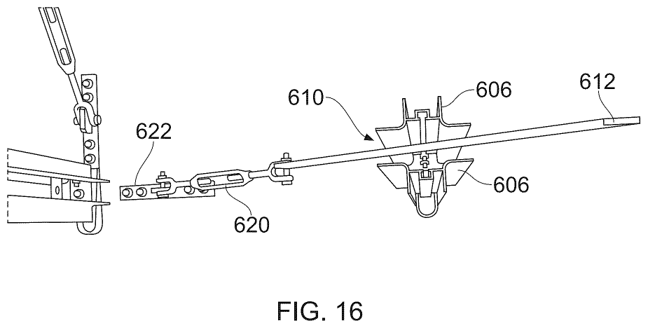

FIG. 16 is a sectional view more clearly showing bracing member 612 passing through space 610 between upright member sections 606.

FIGS. 17-20 illustrate an advantage of the arrangement of the invention. As shown, a storage container 106 arranged in a storage column 105 adjacent to bracing member 612 and connection plates 622 will not have its vertical movement interfered with, as the bracing member passes through the twin-post upright member 602. While FIG. 17 illustrates the bracing member and upright member sections 606 arranged along periphery 604 and a storage column thus being arranged only to one side of bracing member 612, it can be appreciated that row 604 may be arranged in the interior of framework and the bracing member would avoid interfering with containers in storage columns on all sides of bracing member 612.

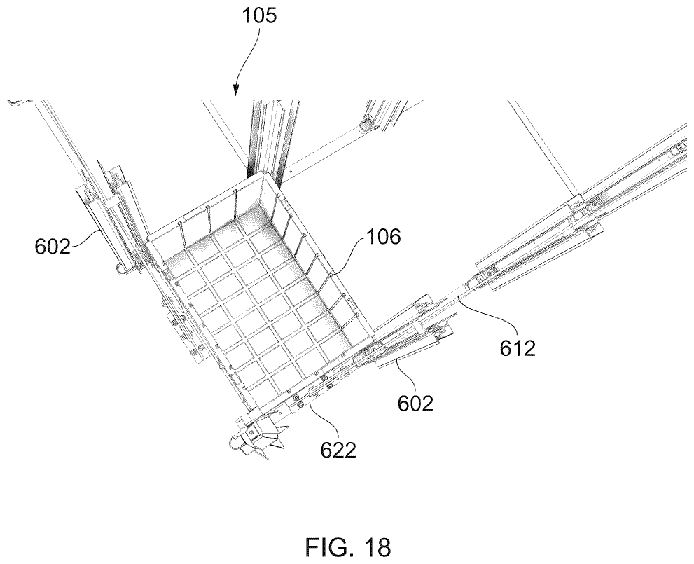

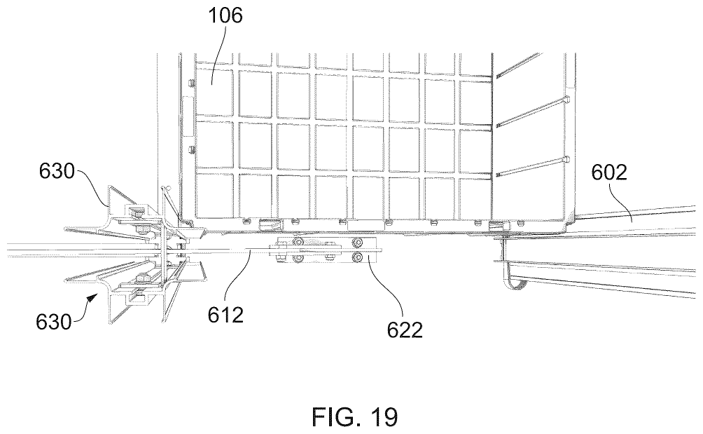

FIGS. 18 and 19 illustrate that upright member sections 606 comprise elongated corner guide profiles 630 that have a shape adapted to receive and vertically guide the movement of corresponding corners of storage containers 106. When a twin-post upright member 602 comprises one of the four upright members that define a storage column (that may include prior art upright members 102), the corner guide profiles 630 will cooperate with similar corner guide profiles of the remaining upright members to form a vertical guide path for the storage container, free from interference from bracing member 612.

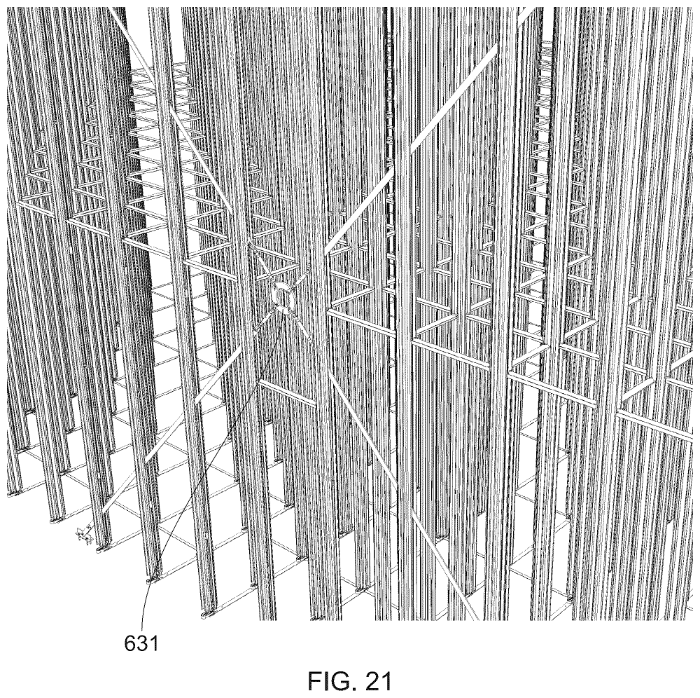

FIGS. 21-24 illustrate an embodiment where multiple bracing members 612 are connected to a central hub member 631. This arrangement may be useful in particularly large framework structure where very long bracing members would be unwieldy.

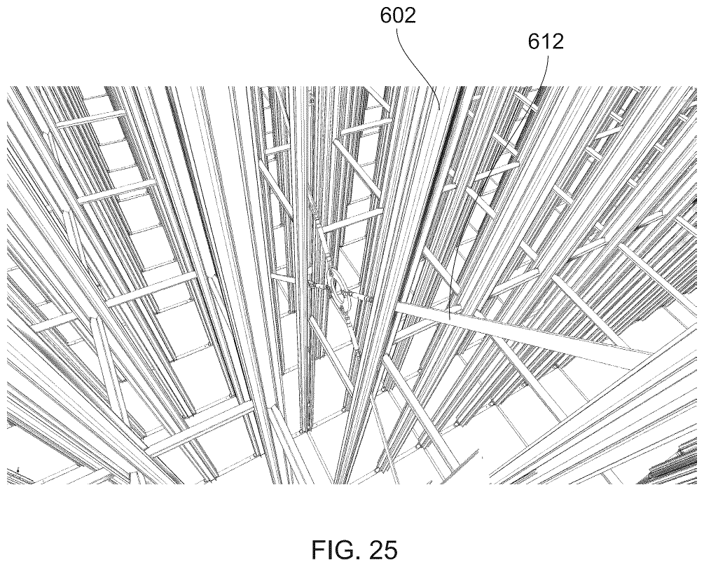

FIG. 25 illustrates a bracing arrangement according to the invention arranged in an interior portion of the framework structure. It should be understood that the term “interior” may mean any portion of the framework structure that is internal to the periphery.

### LIST OF REFERENCE NUMBERS

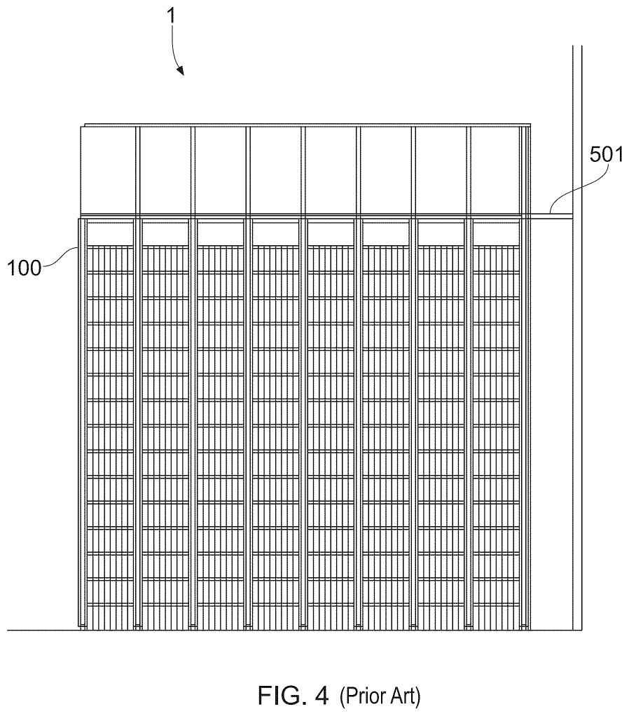

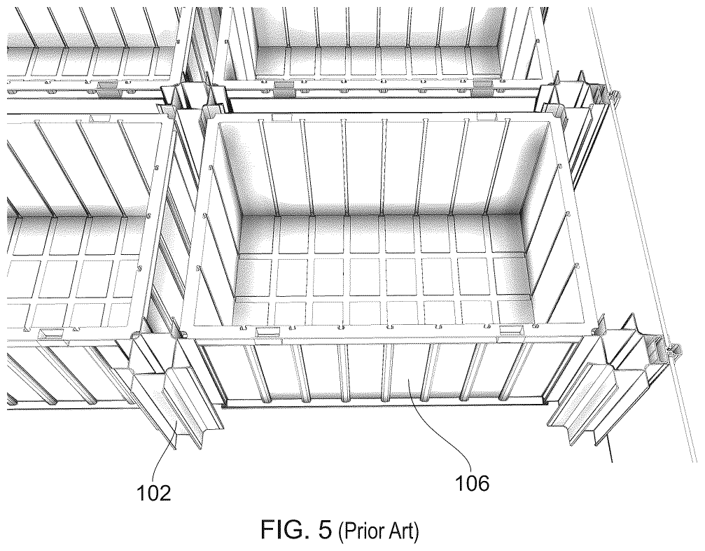

### Prior Art (FIGS. 1-4)

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
304 Gripping device
500 Control system
501 Beams
X First direction
Y Second direction
Z Third direction
600 Periphery
602 Twin-post upright member
604 Row
606 Upright member sections
608 Spacers
609 Lowermost spacer
610 Space
611 Hole or slot
612 Bracing member
613 Leveling foot device
614 First connection point
616 Second connection point
618 Floor
620 Tensioning means
624 Articulated connection piece
626 Forked connector
628 Connection bracket
630 Corner guide profile
631 Connection hub member

1. A bracing arrangement for a framework structure of an automated storage and retrieval system, comprising:
a plurality of upright members arranged in rows defining storage columns, the upright members supporting a rail system comprising first and second sets of parallel rails upon which travel container handling vehicles for retrieving containers or other items stored in the storage columns,
wherein a plurality of twin-post upright members arranged in at least one row of the framework structure, the twin-post upright members comprising a pair of upright member sections arranged with a space therebetween,
wherein at least one elongated bracing member connected at a first end to a first upper connection point and at a second end to a second lower connection point in order to brace the framework structure,
wherein each elongated bracing member arranged to pass diagonally through the spaces between the vertical sections of the pairs of upright member sections of the plurality of twin-post upright members arranged in the at least one row.

2. The bracing arrangement according to claim 1, wherein at least one row is arranged at a periphery of the framework structure.

3. The bracing arrangement according to claim 1, wherein the bracing member is arranged diagonally, with the first connection point being a floor of facility in which the framework structure is erected, and/or with the second connection point being a rail of a rail system upon which vehicles of the automated storage and retrieval system operate.

4. The bracing arrangement according to claim 3, wherein the bracing member is connected to the rail system by a connection plate, wherein the width of said connection plate does not exceed the width of the rails of the rail system.

5. The bracing arrangement according to claim 1, wherein the elongated bracing member comprises tensioning means.

6. The bracing arrangement according to claim 5, wherein the tensioning means is a turnbuckle.

7. The bracing arrangement according to claim 1, wherein a plurality of bracing members are connected to a hub member.

8. A twin-post upright member of a framework structure of an automated storage and retrieval system, comprising a pair of upright member sections separated by spacers, so as to create a space between the upright member sections, the upright member sections further comprising elongated corner guide profiles arranged to vertically guide a container in a storage column defined by four upright members.

9. The twin-post upright member according to claim 8, wherein a lowermost spacer comprises a hole or slot for engaging a leveling foot device.

10. A method for bracing a framework structure of an automated storage and retrieval system, comprising:
arranging a plurality of twin-post upright member of a framework structure of an automated storage and retrieval system, comprising a pair of upright member sections separated by spacers, so as to create a space between the upright member sections, the upright member sections further comprising elongated corner guide profiles arranged to vertically guide a container in a storage column defined by four upright members as at least one row of upright members of the framework structure,
connecting a first end of an elongated bracing member to a floor of the facility in which the framework structure is erected or to a rail of a rail system upon which vehicles of the automated storage and retrieval system operate,
passing the elongated bracing member diagonally through the space between upright member sections of multiple adjacent upright members of the row,
connecting a second end of the elongated bracing member to the floor or rail.

11. The method for bracing a framework structure according to claim 10, wherein the elongated bracing member comprises tensioning means, and the method further comprises the step of tensioning the bracing member.

12. The method for bracing a framework structure according to claim 10, wherein at least one row is along a periphery of the framework structure.

13. The method for bracing a framework structure according to claim 10, wherein the bracing member is connected to the rail by a connection plate that does not exceed the width of the rail.
